(19) United States
(12) Patent Application Publication
(10) Pub. No.: US 2013/0090987 A1
(43) Pub. Date: Apr. 11, 2013

(54) METHODS AND SYSTEM FOR WORKFLOW MANAGEMENT OF SALES OPPORTUNITIES

(71) Applicant: OPNET Technologies, Inc., Bethesda, MD (US)

(72) Inventor: Marc A. COHEN, McLean, VA (US)

(73) Assignee: OPNET Technologies, Inc., Bethesda, MD (US)

(21) Appl. No.: 13/645,688

(22) Filed: Oct. 5, 2012

Related U.S. Application Data
(60) Provisional application No. 61/543,919, filed on Oct. 6, 2011.

(51) Int. Cl. G06Q 30/02

(52) U.S. Cl. 705/7.34; 705/7.29

(57) ABSTRACT

The embodiments relate to tracking some or all of the sales opportunities at a particular firm through an active business cycle. An active business cycle is representative of the progression of sales opportunities from beginning to end. Within an active business cycle, a sales opportunity may be categorized according to the stage through which the opportunity has progressed. Sales opportunities in the active business cycle are tracked and segmented according to their age, such as when they became active. The sales information may then be queried and graphically displayed with a representation of a plurality of opportunities according to their age.

### CROSS-REFERENCE TO RELATED APPLICATION

This application claims the benefit of U.S. Provisional Patent Application No. 61/543,919, filed Oct. 6, 2011, and entitled “Sales Opportunity Analysis,” which is herein incorporated by reference in its entirety.

### BACKGROUND

When dealing with complex goods or services, particularly in larger organizations, it is critical for the company selling those goods and services to track the corresponding sales performance relative to employees, geographic regions, departments, and other relevant organizational criteria. Furthermore, sales transactions typically progress through a pipeline having multiple stages or phases. Accordingly, organizations typically track such transactions according to their stage in the pipeline.

However, with new sales opportunities continuously entering the pipeline and progressing at different rates, it is a complex and time-consuming task for the company to accurately gauge sales performance for any given period of time. For example, once a potential sale becomes more than just a lead, many months may pass before there is a final disposition. Some complex sales may require participation from numerous internal departments (e.g. sales, finance, and legal depts.), and a variety of externalities may influence whether a sale is ultimately successful or not. Other sales (e.g. those with existing customers) may complete much more quickly.

Furthermore, sales opportunities may become lost for any number of reasons, and management may gather different information from sales that are lost to competitors compared to sales that are lost for other reasons (e.g. budgetary constraints). For these reasons, prior art techniques for simply tracking sales by their stage and comparing the numbers of successful and unsuccessful sales over a period of time are insufficient. Accordingly, it would be desirable to provide methods and systems for tracking sales and sales opportunities in ways that consider additional informative characteristics of the sales and opportunities.

### BRIEF DESCRIPTION OF THE DRAWINGS

The invention is explained in further detail, and by way of example, with reference to the accompanying drawings wherein:

FIG. 1 illustrates an exemplary system in accordance with embodiments of the present invention;

FIG. 2 illustrates an exemplary sales cycle, such as an active business cycle, used in various embodiments of the present invention and FIGS. 2A and 2B illustrate how the probability of a lead progressing to closure or purchase may evolve over the course of a business cycle;

FIG. 3 illustrates an exemplary process flow of the present invention; and

FIGS. 4A-4C illustrates an exemplary sales report in accordance with embodiments of the present invention.

Throughout the drawings, the same reference numerals indicate similar or corresponding features or functions. The drawings are included for illustrative purposes and are not intended to limit the scope of the invention.

### DETAILED DESCRIPTION

Overview

Prior art tools do not provide a simple way to compare a desired business plan to the progression of actual leads and sales through a sales cycle. Thus, users cannot easily assess whether present sales are in line with a desired plan. For example, a tool that only indicates the total number of sales opportunities in each stage of a sales cycle provides no information about how quickly sales are progressing, which opportunities have stalled, or how much sales activity occurred during a particular period of time. As a result, the prior art provides little insight as to how a company can achieve a desired number of sales.

Accordingly, it would be desirable to quickly assess the relative progress and status of a large number of sales opportunities. In some embodiments, sales opportunities can be tracked and assessed based on the time periods in which the opportunities first materialized. For example, the age of a sales opportunity as well as its stage of progression may be provided by the embodiments.

In general, a sales “cycle” is employed as a model used to visualize the progress of sales opportunities as they progress from an initial opportunity stage through a final stage. A sales opportunity may be characterized as a series of interactions with a prospective buyer of goods or services. This series of interactions translates to a common cycle of events and stages that an opportunity will go through before it leads to a successful or unsuccessful sale.

In some embodiments, the present invention permits a user to easily track some or all of the sales opportunities at a particular organization through an active business cycle. An active business cycle is representative of the progression of sales opportunities from beginning to end. Within an active business cycle, a sales opportunity may be categorized according to the stage through which the opportunity has progressed. For example, a new opportunity may be classified as “open,” an unsuccessful opportunity may be classified as “lost” or “closed,” and an opportunity resulting in a sale may be classified as a “purchase.”

In contrast to conventional sales tools, the active business cycle of sales opportunities can be viewed with respect to their age, such as the time period in which sales opportunities first became active or materialized within the active business cycle. In other words, it is insufficient to simply know that there are N opportunities presently open, where some opportunities may be brand new and others may be many months old. Instead, in some of the embodiments, sales opportunities in the active business cycle are segmented according to their age, such as when they became active. In this manner, the methods and systems of the invention can, among other things, quickly gauge the progress of a diverse and constantly changing set of opportunities. For example, in some embodiments, the progression of each sales opportunity within the active business cycle is recorded and tracked in a database. The sales information may then be queried and graphically displayed with a representation of a plurality of opportunities in a manner that permits efficient and intuitive analysis.

Certain embodiments of the inventions will now be described. These embodiments are presented by way of example only, and are not intended to limit the scope of the inventions. Indeed, the novel methods and systems described herein may be embodied in a variety of other forms. Furthermore, various omissions, substitutions and changes in the form of the methods and systems described herein may be made without departing from the spirit of the inventions. For example, for purposes of simplicity and clarity, detailed descriptions of well-known components, such as circuits, are omitted so as not to obscure the description of the present invention with unnecessary detail. To illustrate some of the embodiments, reference will now be made to the figures.

System Architecture

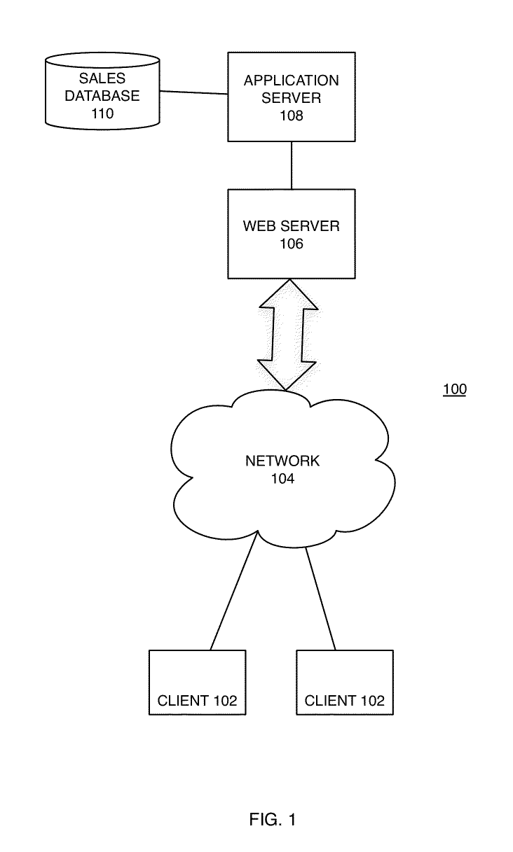

FIG. 1 is a simplified block diagram of a sales management system 100 that comprises a plurality of clients 102, a network 104, a web server 106, an application server 108, and a sales database 110. In general, the sales management system 100 tracks sales within an active business cycle from opening to completion and provides a status of these opportunities. In some embodiments, system 100 supports various roles for sales personnel and provides access to individuals based on the position held by the individual within the company.

In general, the data for system 100 may be entered and updated by sales personnel or support staff on a continuous basis via clients 102. In one embodiment, clients 102 refer to any computer used by a user to access the data hosted by the system 100. The clients 102 can be implemented on any type of computing device, such as a desktop computer, laptop computer, tablet, smart phone, etc. Such devices are well-known to those skilled in the art. In the embodiments, the clients 102 typically provide a web browser (not shown) to access the data of the system 100. Of course, in other embodiments, the clients 102 may execute an application or other type of software to access the sales data of system 100.

Accordingly, the clients 102 may access various applications of system 100 based on client software running or installed on the clients 102. The clients 102 may execute a thick client, a thin client, or hybrid client. For example, the clients 102 may access applications via a thin client, such as a browser application like Internet Explore, Firefox, etc. Programming for these thin clients may include, for example, JavaScript/AJX, JSP, ASP, PHP, Flash, Silverlight, and others. Such browsers and programming code are known to those skilled in the art.

Alternatively, the clients 102 may execute a thick client, such as a stand-alone application, installed on the clients 102. Programming for thick clients may be based on the .NET framework, Java, Visual Studio, etc.

The network 104 provides a communications infrastructure to interconnect the clients 102 with the other components of the system 100. For example, the network 104 may connect clients 102 through various interfaces, such as a local area network (LAN), wireless network, a cellular network, a wide area network (WAN), and the like.

In some embodiments, the system 100 utilizes a web-enabled interactive database to facilitate tracking and management of the active business cycle. Accordingly, the system 100 may comprise a web server 106 to assist in receiving sales lead information and provide information upon request. The web server 106 provides a front-end interface for clients 102 and may be implemented using known hardware and software. For example, clients 102 may employ their browser as a web interface for user input and reports.

Web server 106 thus provides content for system 100 over a network, such as network 104. Web server 104 may be implemented using known hardware and software to deliver application content. For example, web server 104 may deliver content via HTML pages and employ various IP protocols, such as HTTP.

Application server 108 and sales database 110 provide a centralized repository of the sales data for the active business cycles of a company. In one exemplary embodiment, application server 108 and database 110 implement a relational database for storing sales information. Information can be accessed in the database 110 through queries, such as Structured Query Language (SQL) queries.

In some embodiments, application server 108 may be implemented as Java Application Servers, Windows Servers implementing a .NET framework, LINUX, UNIX, WebSphere, etc. running on known hardware platforms. Application server 108 may be implemented on the same hardware platform as the web server 106, or each may be implemented on their own separate hardware.

In addition, application server 108 provides database services for access to database 110 for transactions and queries requested by clients 102. Application server 108 may be implemented using known hardware and software. For example, application server 108 may be implemented based on Oracle, DB2, Ingres, SQL Server, MySQL, etc. software running on a server.

Furthermore, in some embodiments, the application server 108 may be configured to perform other processing of the sales opportunities. For example, since each sales opportunity is tracked based on its age and when it first materialized within the active business cycle, the application server 108 may calculate various probabilities for each sales opportunity. In general, sales opportunities can be assumed to have a finite lifetime within their active business cycle. This finite lifetime may be based on observed data or set by default by the company. Thus, as a sales opportunity ages, its probability of progressing to one or more stages can possibly be deterministically calculated.

Based on a history of previous sales opportunities with similar characteristics, the application server 108 may implement a model that predicts when the sales opportunity will close or result in a purchase. The application server 108 may calculate the probability of a purchase resulting from a given sales opportunity based on when that sales opportunity became active, the sales person, the region, the customer, the age of the sales opportunity, the monetary value, the competitors, etc. The application server 108 may consider any of these factors alone or in combination.

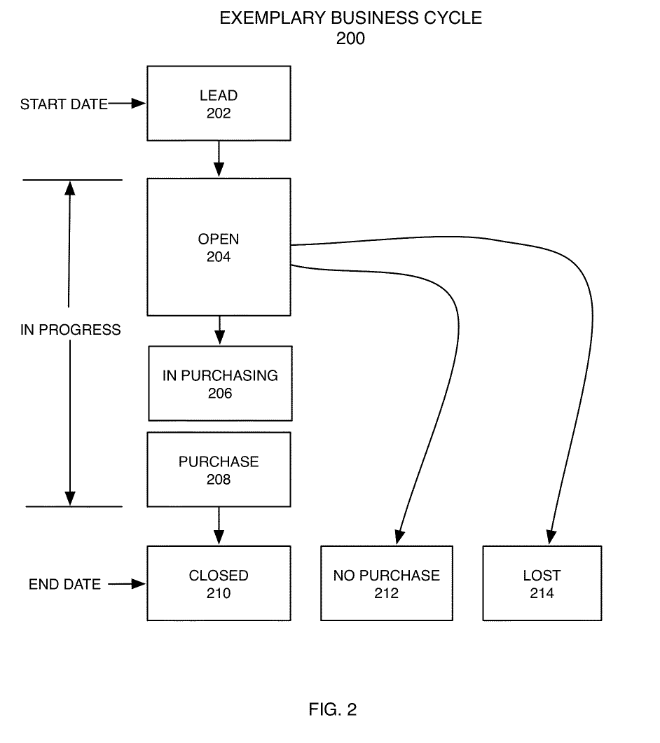

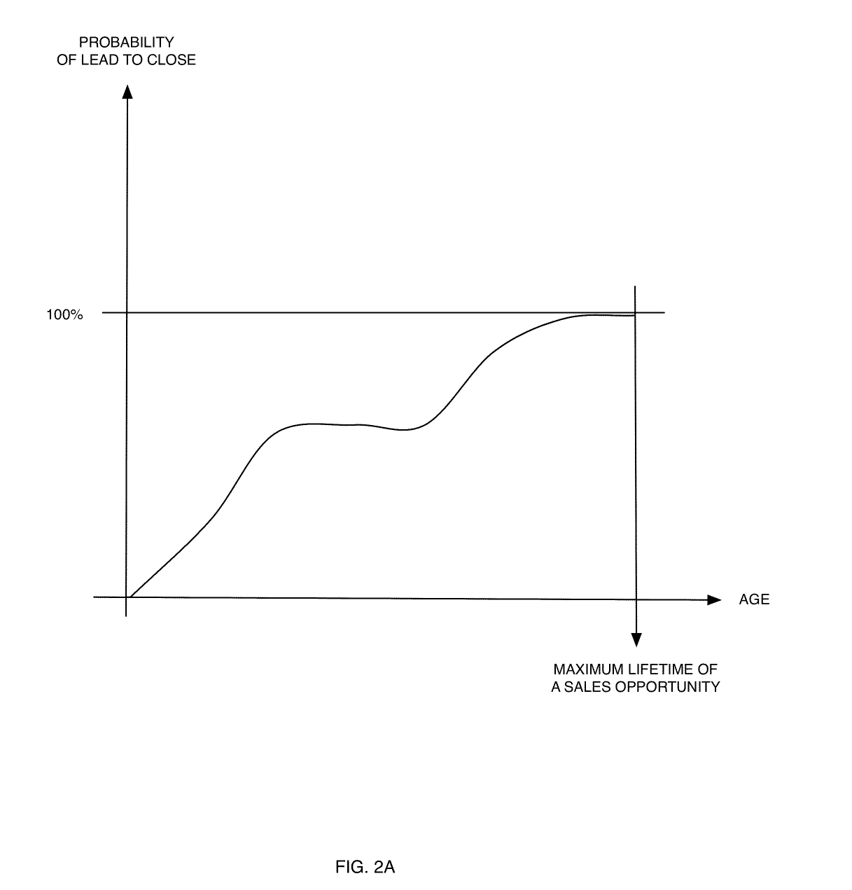

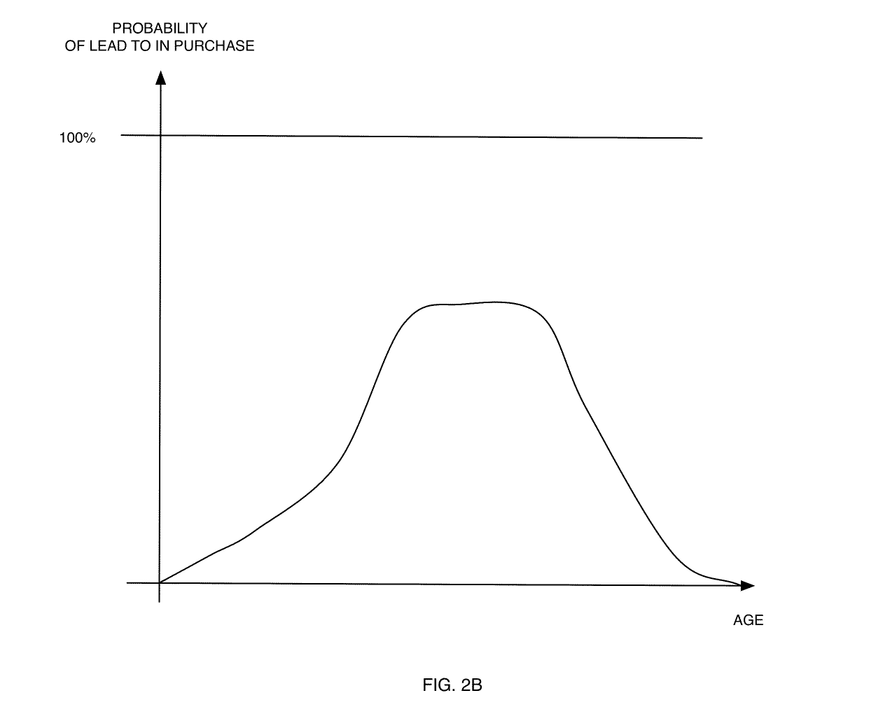

For example, as shown in FIG. 2A, early in a sales opportunity cycle, the likelihood of closure (to purchase or other reason) is relatively low because, especially for complex products, the customer and sales staff will take time to present the information and negotiate the terms. However, the probability of closure, for example, due to purchase or loss, increases as time passes. Eventually, all sales opportunities should be updated to a conclusion, such as no purchase or lost within a finite period.

As another example, FIG. 2B illustrates the probability of a sales opportunity progressing from a lead to a purchase. Over time, the probability may initially rise, then peak for a certain period of time, and then fall, perhaps, eventually to zero.

In the embodiments, it may be assumed that the age of the sales opportunity is the primary measurement criteria for probability (rather than its current stage). The probabilities affecting a sales opportunity may depend on a variety of other factors. Historical data that is premised on these various factors may be factored into an algorithm to measure and predict how a sales opportunity progresses. Such factors may include the time of year, the sales person, the sales region, the product, the pricing or monetary value, the customer, the number of competitors, etc.

This information may be useful because it not only provides information on the overall likelihood of success or failure of various sales opportunities, but also when appropriate action should be taken relative to the age of the sales opportunity. Prior art systems and methods merely rely upon the current stage of the sales opportunity for reporting purposes etc. In contrast, the present invention enables a more efficient analysis of sales opportunities based on when they first materialized in the active business cycle.

For example, the application server 108 may indicate probabilities of sales opportunities as a group or individually. In addition, the application server 108 may indicate a trend or other information to report on each sales opportunity's chance of proceeding. The probabilities may be indicated visually in various ways, such as color-coding, pop-up windows, etc.

The application server 108 may track the intervals of each sales opportunity as it progresses through the stages of the active business cycle. In one embodiment, these intervals may be compiled into a matrix or array of values upon which various calculations can be performed. Table 1 below illustrates an example of such a matrix.

| | | | | NO | |
|---|---|---|---|---|---|
| | LEAD | OPEN | PURCHASE | PURCHASE | LOST |
| Opportunity #1 | | | | | |
| Opportunity #2 | | | | | |
| Opportunity #3 | | | | | |
| Opportunity #n | | | | | |

As shown, the application server 108 may record the intervals for each sales opportunity as it changes stages within the active business cycle. The intervals may be recorded based on date and timestamps so that the application server 108 can interpret not only the length of the interval, but also the relative day, month, etc., of the change. From this information, the application server 108 may construct an array or matrix of values to determine the probability of success. Any form of statistical analysis may be performed in the embodiments.

Of note, the application server 108 may build various tables specific to various aspects of the sales opportunity. The application server 108 may build tables by sales person, by product, by geographic region, by season, etc.

Various applications of the probabilities can be implemented by the present invention. For example, based on the probabilities, the system 100 may calculate estimated future sales by the company based on the current inventory of sales opportunities in the active business cycle and their ages. The predictions can be provided in aggregate or specific to sales persons, products, regions, etc. Such predictions may be particularly useful to company's attempting to implement a strategic sales plan, sales campaign, etc. Notably, the predictive calculations by the embodiments may be more accurate since they are based on objective data regarding the age of each sales opportunity and its effect on each opportunity's progress through the active business cycle.

Age of Next Action=C₁*Current Age+C₂*Offset Factor, Example Formula:
where C₁ and C₂ are weighting coefficients,
where the Offset Factor is a function of the selected characteristic, such as sales person, region, etc.

The offset factor can be either positive or negative. For example, the basic offset factor may be based on a mean or median observed from the historical data. A well-performing sales person may thus affect the sales cycles positively, and thus, result in a negative offset factor overall, which results in a shorter amount of time to the next action, i.e., the sales person moves the sales cycle to its next stage or action more quickly. As another example, sales opportunities for a certain product may be longer relative to other products, and thus, result in a positive offset factor

Database 110 represents the storage infrastructure for data and information requested by clients 102. Database 110 may be implemented using known hardware and software for storing the data of the active business cycles. For example, as noted, database 110 may be implemented as a relational database based on known database management systems, such as SQL, MySQL, etc. Database 110 may also comprise other types of databases, such as, object oriented databases, XML databases, and so forth.

Exemplary Active Business Cycle

As noted, sales opportunities of a company may progress through a cycle having various stages. One example of an active business cycle is provided herein to illustrate some embodiments of the present invention.

As shown, an active business cycle 200 may comprise various stages to track the progress of sales by a company. For example, once a potential buyer has expressed interest in a particular good or service, a sales opportunity may be classified as a “lead.” Accordingly, in the lead stage 202, information concerning the buyer, the salesperson, the current date, and the good or service itself may be entered into the sales database 110.

Next, the company may pursue the lead. Thus, as various tasks are performed to complete a sale, the opportunity can be classified as being in an “open” stage 204 with respect to the active business cycle 204. As the opportunity remains open and progresses through the cycle, the same or different personnel may add additional information and alter the status of the database record.

If a buyer decides to make a purchase, and the sale is transferred to the purchasing department, the status of the opportunity may be updated and classified as being in the “in purchasing” stage 206. Eventually, the sales opportunity may be completed, and the active cycle business is updated to the “purchase” stage 208.

Various updates, such as contract information, final price, etc., may then be entered into the sales database 110. The active business cycle for that opportunity is then updated to “closed” 208 and tagged with an ending date to end the active business cycle 200.

Of course, in other instances, a sales opportunity may or may not lead to a successful sale. For example, in some embodiments, the active business cycle 200 may comprise a “no purchase” stage 212 to indicate that the sale was not completed for various reasons, such as budget constraints by the customer. As another example, in some embodiments, the active business cycle 200 may comprise a “lost” stage 214 to indicate that the sale was lost to a competitor.

The sales database 110 may be updated as sales opportunities progress within the active business cycle 200 to indicate various types of information, such as price proposals, requested terms, contracts, etc.

Exemplary Process Flow

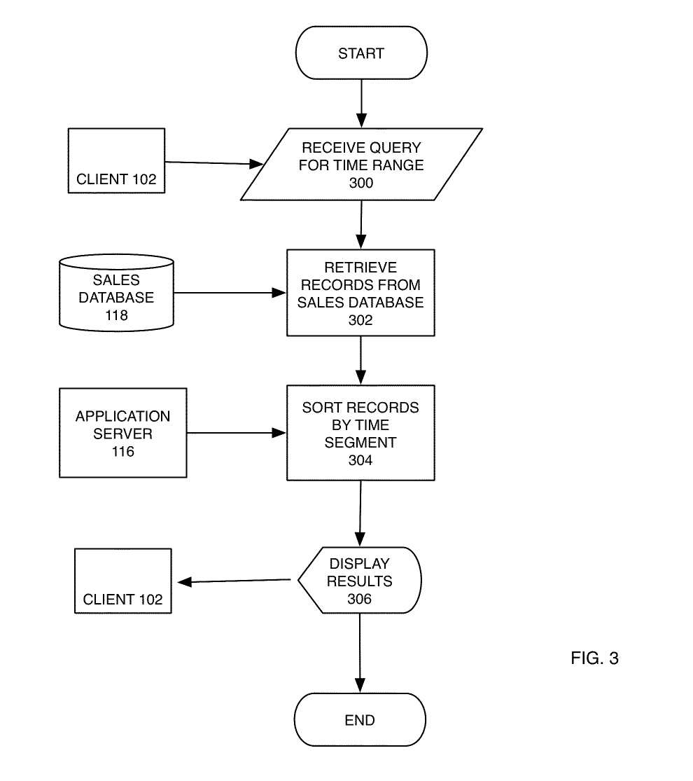

FIG. 3 illustrates an exemplary process flow of an embodiment of the present invention. In general, the system 100 maintains and tracks active business cycles from lead to follow-up to close. When performing its processes, the web server 106 and application server 108 may receive sales information from clients 102 in various formats. In addition, the web server 106 and application server 108 may provide sales information within active business cycles in a displayable format, such as a web page, and in a format that can be used by other software tools, such as Microsoft Excel or Microsoft Access by clients 102.

In stage 300, a user at client 102 submits a query for sales information. As noted, the client 102 may employ a web interface via a web browser to interact with various pages served by web server 106. The web server 106 may then submit the query or queries to the application server 108. The application server 108 interprets the query, and in response, queries the database 110 for the relevant records. In some embodiments, the query from the client 102 specifies a time period or range.

In stage 302, the application server 108 retrieves the relevant records from the database 110. As noted, the application server 108 may employ SQL queries and receive the various records from the database 108 for sales opportunities within the active business cycle that became active or materialized within the specified time period or range.

In stage 304, the application server 108 compiles the records and sorts them by time segments. Alternatively, the web server 106 may perform this function in other embodiments.

The sorted sales information and records is passed to the web server 106. In response, the web server 106 formats the information into a displayable format, such as an HTML web page, and sends the information to the client 102.

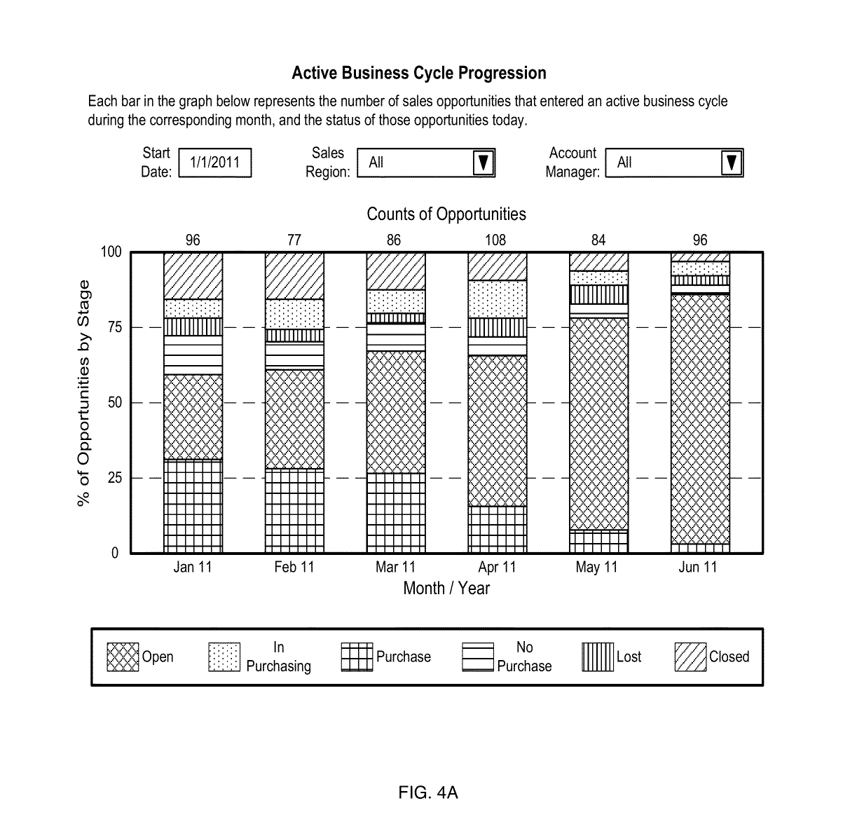

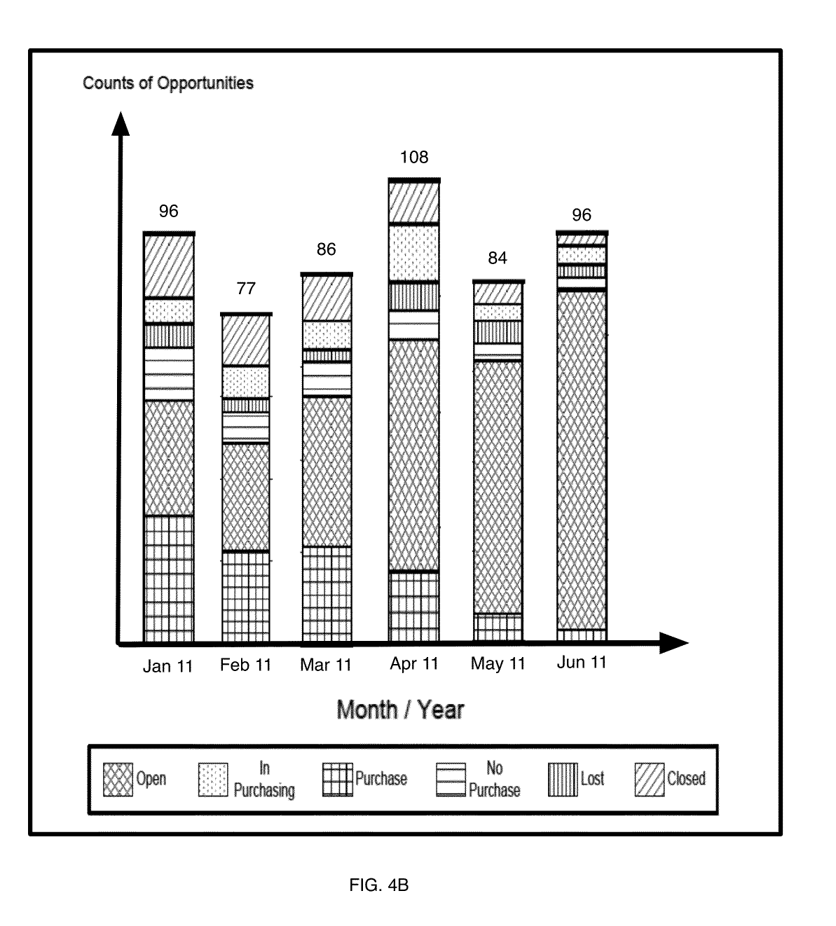

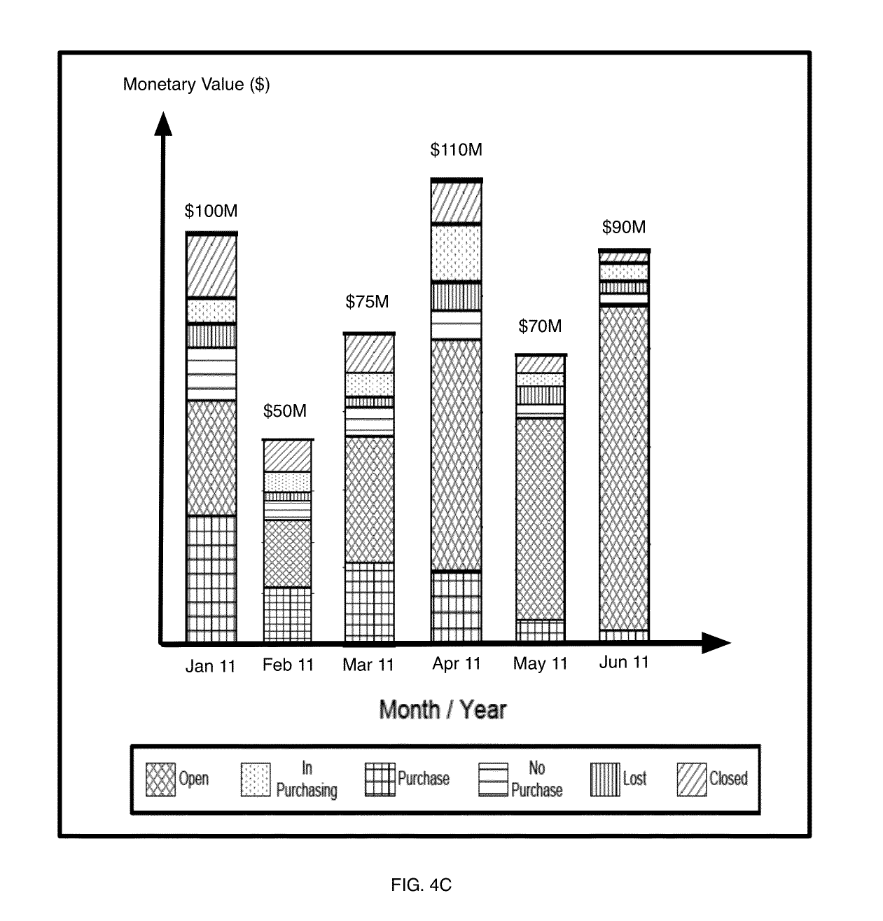

In stage 306, the client 102 receives the sales record information from the web server 106. The client 102 may then display the information to a user, for example, using a browser or other application. An exemplary display is provided in FIGS. 4A-4C, which are further described below.

The user at client 102 may then interact and view the sales information. For example, the user may “click” or select one or more segments of the sales information to request and view more detailed information. In addition, the user at client 102 may modify or reformat the view of the information. For example, the sales information may be viewed on a scale to indicate the absolute number of sales opportunities within a time segment, the monetary value of the opportunities, the probability that each opportunity will result in a purchase, etc.

FIGS. 4A-4C illustrate exemplary displays for representing a plurality of opportunities based on their current stage in the active business cycle and the time period in which they first became active. For example, opportunities may be classified according to one of six stages: open, in purchasing, purchase, no purchase, lost, or closed. Any time period may be used (e.g. daily, weekly, monthly, etc.). In FIGS. 4A-4C, the user has chosen to view monthly time periods starting on Jan. 1, 2011. The bar for each month represents the total number of opportunities that became active during that month.

In FIG. 4A, the total opportunities are then broken down by current stage, whereby each stage is represented as a percentage of the total opportunities. For example, a user can thus quickly see that of the 96 opportunities that became active in January of 2011, about 30% have resulted in a purchase, about 25% are still open, and so on.

In alternative embodiments, each opportunity can be represented as a raw number instead of a percentage (in which case the bars would be different heights based on the total number of opportunities), as a monetary value of the opportunity, as a probability that is indicative of how likely the opportunity will result in a sale (e.g., based on a history of previous sales opportunities), etc.

For example, in FIGS. 4B and 4C, each bar for a time segment may have different heights depending on the scale or presentation. A taller bar may represent a time segment having a higher number of sales opportunities, as shown in FIG. 4B, or a higher monetary value, as shown in FIG. 4C, relative to other time segments and vice versa. Of course, other shapes, dimensions, colors, etc. may be varied to represent various aspects of the sales opportunities. For example, other types of representations, such as pie charts, may be used to represent the sales opportunities.

In addition to viewing totals and percentages, users can also observe trends across extended periods of time. For example, users can gauge how quickly opportunities move through the active business cycle or whether sales personnel are regularly meeting certain goals. Opportunities can also be filtered according to various criteria. For example, a user might only want to view opportunities for a particular geographic region or those associated with a particular sales person, manager, etc.

Users can further interact with the graphical interface illustrated in FIG. 4A by “drilling” into any of the individual components. For example, if a user double-clicked on the “open” portion of the “Jan 11” bar, the web server 106 may provide information, such as a uniform resource locator (“URL”) or other information that would allow the client 110 to present the user with more detailed information about the “open” sales opportunities corresponding to that time period. This additional information may include the specifics of each opportunity and/or it may include other aggregations of data.

In summary, the present invention improves upon prior art techniques for tracking and analyzing sales opportunities. Specifically, it utilizes a database to track the status of a plurality of sales opportunities as they progress through an active business cycle, and it presents a novel graphical display that enables a user to quickly and intuitively assess the status of numerous sales opportunities within the active business cycle.

Although the present disclosure provides certain embodiments and applications, other embodiments that are apparent to those of ordinary skill in the art, including embodiments that do not provide all of the features and advantages set forth herein, are also within the scope of this disclosure. Accordingly, the scope of the present disclosure is intended to be defined only by reference to the appended claims. The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

What is claimed is:

1. A method for analyzing the progression of a plurality of sales opportunities, comprising:
receiving information related to a plurality of sales opportunities and indicating when each sales opportunity became active;
storing, in a database, a record for each of the plurality of sales opportunities, each sales opportunity having a corresponding status and date when the opportunity became active;
querying, responsive to an input received from a client, the database for sales opportunities that became active within a range of time;
retrieving, from the database, a plurality of the records for sales opportunities that became active within the range of time; and
sending, to a client, information corresponding to the retrieved records that can be graphically displayed, wherein the information, when graphically displayed, is segmented into a plurality of time periods, the graphical information for each time period indicating both a total number of sales opportunities that became active during that time period, and the status of the sales opportunities corresponding to that time period.

2. The method of claim 1, wherein sending to the client information corresponding to the retrieved records comprises sending information indicating a uniform resource locator for the retrieved records in the database.

3. The method of claim 1, wherein querying the database for sales opportunities further comprises determining a set of filtering criteria based on the input received from the client.

4. The method of claim 3, further comprising filtering the retrieved records for sales opportunities related to a product.

5. The method of claim 3, further comprising filtering the records for sales opportunities based on an identified sales person.

6. The method of claim 3, further comprising filtering the records for sales opportunities based on a geographic region.

7. The method of claim 1, further comprising determining a probability of sales opportunities leading to a purchase based at least partially on when the opportunity became active.

8. A method for viewing sales opportunities tracked by a computer system, wherein the sales opportunities are tracked based on when each sales opportunity became active and a corresponding status within a cycle, said method comprising:
sending, responsive to an input received from a client, a query requesting information for sales opportunities that became active within a range of time; and
receiving information corresponding to the retrieved records that can be graphically displayed; and
graphically displaying the information from the retrieved records, wherein the information, when graphically displayed, is segmented into a plurality of time periods, the graphical information for each time period indicating both a total number of sales opportunities that became active during that time period, and the status of the sales opportunities corresponding to that time period.

9. The method of claim 8, wherein graphically displaying the information comprises graphically displaying sales opportunities within each time period based on a scale relative to a total number of sales opportunities within that time period.

10. The method of claim 8, wherein graphically displaying the information comprises graphically displaying sales opportunities within each time period based on a scale relative to a monetary value of the sales opportunities within that time period.

11. The method of claim 8, wherein graphically displaying the information comprises graphically displaying sales opportunities within each time period based on a uniform scale to indicate relative percentages of stages within the cycle for the sales opportunities within that time period.

12. The method of claim 8, further comprising:
receiving a user input requesting information about sales opportunities within a time period;
sending a query for the requested information; and
graphically displaying the requested information.

13. The method of claim 8, wherein sending the query requesting sales opportunities comprises sending a query specifying sales opportunities belonging to at least one identified sales person.

14. The method of claim 8, wherein sending the query requesting sales opportunities comprises sending a query specifying sales opportunities associated with a geographic region.

15. The method of claim 8, wherein sending the query requesting sales opportunities comprises sending a query specifying sales opportunities based on a threshold age.

16. The method of claim 8, wherein sending the query requesting sales opportunities comprises sending a query specifying sales opportunities for at least one specified product.

17. The method of claim 8, wherein sending the query requesting sales opportunities comprises sending a query specifying sales opportunities based on a threshold monetary value.

18. A system configured to analyze the progression of a plurality of sales opportunities, comprising:
an interface configured to receive information related to a plurality of sales opportunities and indicating when each sales opportunity became active;
a database storing a record for each of the plurality of sales opportunities, each sales opportunity having a corresponding status and date when the opportunity became active;
a processor, configured by executable program code, to query, responsive to an input received from a client, the database for sales opportunities that became active within a range of time, retrieve, from the database, a plurality of the records for sales opportunities that became active within the range of time, and send, to a client, information corresponding to the retrieved records that can be graphically displayed, wherein the information, when graphically displayed, is segmented into a plurality of time periods, the graphical information for each time period indicating both a total number of sales opportunities that became active during that time period, and the status of the sales opportunities corresponding to that time period.

19. The system of claim 18, wherein the processor is configured to query the database for sales opportunities further comprises determining a set of filtering criteria based on the input received from the client.

20. The system of claim 18, wherein the processor is configured to determine a probability of sales opportunities leading to a purchase based at least partially on when the opportunity became active.
